(19) United States
(12) Patent Application Publication
(10) Pub. No.: US 2023/0141229 A1
(43) Pub. Date: May 11, 2023

(54) RHODOPHYTA-BASED BIOPLASTIC

(71) Applicant: Olivia Reiff Pollock, Village of Pelham, NY (US)

(72) Inventor: Olivia Reiff Pollock, Village of Pelham, NY (US)

(21) Appl. No.: 17/981,585

(22) Filed: Nov. 7, 2022

Related U.S. Application Data
(60) Provisional application No. 63/276,361, filed on Nov. 5, 2021.

(51) Int. Cl. C08L 101/16; C08L 5/12; C08L 1/00

(52) U.S. Cl. CPC C08L 101/16; C08L 5/12; C08L 1/00; C08L 2201/06; C08L 2666/02

(57) ABSTRACT

A bioplastic and method of forming the same are provided. The bioplastic generally includes a Rhodophyta material, agar, and a weak acid. The agar may be combined with water to form a mixture. The agar and water mixture may be combined with the Rhodophyta material and the weak acid to form the bioplastic.

### CROSS-REFERENCE TO RELATED APPLICATION

This application claims the benefit of U.S. provisional patent application Ser. No. 63/276,361, filed 5 Nov. 2021, entitled DEVELOPING AND ASSESSING FUCOSE-BASED WATER-SOLUBLE BIOPLASTICS, the entire disclosure of which is incorporated herein by reference.

### TECHNICAL FIELD

The present disclosure generally relates to bioplastics, and more particularly relates to fructose-based bioplastics.

### BACKGROUND

Plastic waste is an ever increasing problem. The problem of plastic waste is especially prevalent in the world's oceans and waterways. Millions of tons of plastic make its way into oceans and waterways every year, which wreaks havoc on aquatic animals and biota. The plastic waste is not only indigestible by marine life, but additionally, many plastics contain harmful, and even toxic, chemicals that may leach out of the plastic and into the surrounding environment. While there are many sources of plastic waste, the significant prevalence of single use plastics, over the last many decades has been devastating. Single use plastics, which may include items such as take-out containers, food wrappers, shopping bags, coffee cups and plastic bottles, are by their very definite intended to be used once, typically for a relatively short period of time, and then thrown away. While plastic recycling programs have been encouraged for many years, the reality is that most plastic, even plastics that are collected for recycling, are neve in fact recycled, but rather end up in landfills and waterways.

### SUMMARY

According to an implementation a bioplastic includes a Rhodophyta material, agar, and a weak acid.

One or more of the following features may be included. The Rhodophyta material may be provided in the form of algae shavings. The Rhodophyta material may be provided in a powdered form. The bioplastic may include between about 5% to about 40% of the Rhodophyta material by weight. The bioplastic may include between about 10% to about 15% of the Rhodophyta material by weight.

The agar may be provided as a 1:1 agar: water mixture by weight. The bioplastic may include between about 25% to about 90% of the agar: water mixture by weight. The bioplastic may include between about 75% to about 85% of the agar: water mixture by weight.

The weak acid may have a pH of between about 3 to about 6. The weak acid may include citric acid. The bioplastic may include between about 5% to about 40% of the weak acid by weight. The bioplastic may include between about 5% to about 7% of the weak acid by weight.

According to another implementation, a method of making a bioplastic may include providing a 1:1 by weight agar: water mixture. A Rhodophyta material may be provided, and a weak acid may be provided. The method may also include combining the agar: water mixture, the Rhodophyta material, and the weak acid.

One or more of the following features may be included. The method may also include drying the combined agar: water mixture, Rhodophyta material, and weak acid. The Rhodophyta material may include one or more of algae shavings and algae power. Providing the Rhodophyta material may include providing between about 5% to about 40% of the Rhodophyta material by weight. Providing the agar: water mixture may include providing between about 25% to about 90% of the agar: water mixture by weight.

The weak acid may have a pH of between about 3 to about 6. The weak acid may include citric acid. Providing the weak acid may include providing between about 5% to about 40% of the weak acid by weight.

### BRIEF DESCRIPTION OF THE DRAWINGS

FIG. 1 is a table showing mass loss and pH change for experimental test specimen in aqueous environments;

FIG. 2A is a graph depicting mass loss for experimental test specimens in freshwater aqueous environments;

FIG. 2B is a graph depicting mass lock for experimental test specimens in saline aqueous environments;

FIG. 2C is a chart showing pH levels of freshwater aqueous environments for experimental test specimens;

FIG. 2D is a chart showing pH levels of saline aqueous environments for experimental test specimens;

FIG. 3A is an image of the 25% fucose (agar-water mixture) experimental test specimen;

FIG. 3B is an image of the 50% fucose (agar-water mixture) experimental test specimen;

FIG. 3C is an image of the 75% fucose (agar-water mixture) experimental test specimen; and

FIG. 3D is an image of the 90% fucose (agar-water mixture) experimental test specimen.

### DETAILED DESCRIPTION OF EXAMPLE EMBODIMENTS

In general, the present disclosure is directed toward bioplastics that may exhibit beneficial breakdown over a relatively short period of time. In some particular embodiments, bioplastics consistent with the present disclosure may exhibit beneficial breakdown in aqueous conditions. In some embodiments, such beneficial breakdown in aqueous conditions may be observed in both freshwater and saltwater conditions. Further, consistent with some embodiments, bioplastics consistent with the present disclosure may not include a significant source of toxic chemicals, which may leach out of the bioplastics once discarded. Additionally, bioplastics consistent with some embodiments of the present disclosure may include materials from natural sources. Consistent with some such implementations, bioplastics consistent with the present disclosure may include polymer components from natural sources as well as plasticizers from natural sources. In some particular illustrative example embodiments, bioplastics consistent with the present disclosure may exhibit substantial and/or complete beneficial breakdown in sub-year time frames.

Consistent with the present disclosure, a bioplastic may be provided including red algae (e.g., Rhodophyta) derived components. Further, in some implementations, the red algae derived components may be used in combination with a weak acid to produce a bioplastic that exhibits beneficial breakdown in relatively short timeframes. Consistent with a particular illustrative example embodiment, a bioplastic may be provided including a Rhodophyta material, agar, and a weak acid. It will be appreciated that additional and/or alternative components may also be included. Consistent with some embodiments, as will be discussed in greater detail below, generally, bioplastics consistent with the present disclosure may be formed by combining the Rhodophyta material with a prepared agar mixture, and the weak acid.

According to an example embodiment, a bioplastic consistent with the present disclosure may include Rhodophyta material. Rhodophyta is a naturally occurring algae that is abundant in many, typically saltwater, environments. Consistent with various embodiments, the Rhodophyta material used for producing the disclosed bioplastics may include Rhodophyta that is shaved, chopped, or ground to produce shavings, particles, and/or powder materials. While not required, in some implementations, the Rhodophyta material may be produced from substantially dried or dehydrated algae, i.e., algae that has been at least partially dried or dehydrated prior to processing. In other embodiments, the Rhodophyta material may be processed while the algae is fresh and/or at least partially hydrated, and may be subsequently further dried and/or dehydrated. However, it will be appreciated that Rhodophyta materials used for producing bioplastics consistent with the present disclosure may be provided in other forms and/or configurations. Further, the Rhodophyta material used for producing bioplastics consistent with the present disclosure may include a generally dried material, however, it will be appreciated that other configurations and/or forms may also be utilized. For example, the Rhodophyta material may be at least partially hydrated and/or provided as an aqueous paste, slurry, and/or suspension.

Consistent with various embodiments, the bioplastic may include from between about 5% to about 40% Rhodophyta material, by weight of the total bioplastic preparation. Consistent with the foregoing, the indicated content of Rhodophyta material in the bioplastic refers to the content of Rhodophyta material, in a substantially dried and/or dehydrated form, that is utilized for producing the bioplastics (i.e., the content that is combined with the remaining components of the bioplastic during production). As will be discussed in greater detail below, production of the bioplastic may include the use of liquid and/or hydrated components, wherein at least a portion of the liquid may be removed through the complete production process. As such, the identified Rhodophyta material content in the final bioplastic may be outside the referenced Rhodophyta material content. Additionally, as discussed above, the foregoing Rhodophyta material content is made by reference to a substantially dried and/or dehydrated Rhodophyta material. As such, if the Rhodophyta material is not provided in a substantially dried form (e.g., the Rhodophyta material is at least partially hydrated, provided as a paste, slurry, suspension, etc.) the weight content of such Rhodophyta material added for producing the bioplastic may reside outside the above-identified range. Consistent with a particular illustrative example embodiment, the bioplastic may include between about 10% to about 15% of the Rhodophyta material by weight of the total bioplastic preparation. As noted above, the foregoing content is intended to reference a content of substantially dry Rhodophyta material added during the production of the bioplastic, which may vary depending upon hydration levels, and may vary relative to the content in the final resultant bioplastic.

The bioplastic consistent with the present disclosure may further include agar. Agar may include one or more polysaccharides derived from Rhodophyta. In some particular implementations, the agar may be at least partially and/or substantially composes of fucose. Accordingly, while the Rhodophyta material may include shaved, chopped, ground, etc., algae, the agar may generally include generally isolated component and/or aspects of the algae. As is known, agar may, in some commercially available forms, include ingredients and/or components of the algae in addition to the saccharide components. According to an illustrative example embodiment, during the production of bioplastic consistent with the present disclosure, the agar may be provided as an aqueous mixture. In some particular embodiment, the agar may be provided as a 1:1 agar to water mixture by weight. It will be appreciated that the 1:1 agar to water mixture may be varied depending upon processing requirements and other considerations. Accordingly, various additional and/or alternative agar to water mix ratios may be utilized. Consistent with some implementations, an agar to water mixture may be provided in ratios from between about 5:1 to about 1:5, specifically including 5:1, 4:1, 3:1, 2:1, 1:1, 1:2, 1:3, 1:4, and 1:5. It will be appreciated that still greater ranges may be utilized, particularly ratios including greater proportions of water. Such greater water contents may require additional and/or extended post-mixing dewatering steps, as will be discussed in greater detail below. Additionally, while the foregoing illustrative example embodiment include a mixture of agar and water, it will be appreciated that bioplastics consistent with the present disclosure may utilized liquid components other than water and/or liquid components including a mixture of water and other liquids. For example, in an illustrative embodiment, a xanthan gum solution may be utilized. As is generally known, xanthan gum is a polysaccharide, which may be used as a natural food additive. Xanthan gum may form a slightly viscous fluid when combined with water. Additionally, xanthan gum may have naturally basic properties which may aid in neutralization of the final bioplastic, as discussed in greater detail below.

Continuing with the foregoing, in some implementations, agar may be provided as a 1:1 mixture with water (and/or another liquid or mixture of liquids). In some particular implementations, agar, which may often be commercially provided in a powder, granular, or other form, may be mixed with water to form a generally homogenous, uniform, and/or consistent mixture. The agar-water mixture may be combined with the Rhodophyta material and the weak acid and mixed to provide a generally homogeneous, uniform, and/or consistent mixture. Consistent with some embodiments, the bioplastic may include between about 25% to about 90% of the agar: water mixture by weight of the total bioplastic preparation. Consistent with the foregoing, and as generally discussed above with reference to the Rhodophyta material content, the indicated content of agar-water mixture in the bioplastic refers to the content of agar-water mixture, provided in a 1:1 ratio by weight, that is utilized for producing the bioplastics (i.e., the content that is combined with the remaining components of the bioplastic during production). As discussed above, in some implementations an agar to water ratio other than 1:1 may be utilized. Consistent with such embodiments, the content of agar-water mixture combined with the remaining components of the bioplastic may vary. Further, as discussed above, in some implementations the Rhodophyta material may be provided as a paste, slurry, and/or suspension. As such, the content of the agar-water mixture and/or the agar to water ratio of the mixture, may vary. Additionally, it is noted that the previously described content of the Rhodophyta material is based upon a 1:1 ratio of the agar to water mixture. The use of other agar to water ratios may result in corresponding changes in the Rhodophyta content. For example, in some embodiments, the Rhodophyta material content may be adjusted based upon the actual quantity of agar added to the composition (e.g., in situations in which the agar to water mixture is provided having a ratio other than 1:1). It will be appreciated that other implementations may be equally utilized. According to a particular illustrative example embodiment, the bioplastic may include between about 75% to about 85% of the agar-water mixture by weight of the total bioplastic preparation.

As generally discussed above, a bioplastic consistent with the present disclosure may additionally include a weak acid. Consistent with some implementations, the weak acid may have a pH of between about 3 to about 6. According to a particular illustrative example embodiment, the weak acid may include citric acid. Consistent with some such implementations, the citric acid may act as a plasticizer for the bioplastic. As such, the citric acid may increase one or more of the flexibility of the bioplastic, the elasticity of the bioplastic, the ultimate elongation of the bioplastics, etc. In some such implementations, the desired characteristic of the citric acid may be the plasticizing effect, and may not be related to (and/or may not be primarily related to) the acidic character or nature of the citric acid. Consistent with some embodiments, the citric acid may include 100% citric acid, however, in some embodiments, the citric acid may be provided having a lower purity level and/or may be provided including additional components, fillers, or the like. In some illustrative example implementations, the citric acid may be at least partially neutralized prior to mixing with the remaining components of the bioplastic, and/or the neutralizing agents may be included in the production process of the bioplastic to at least partially neutralize the citric acid. For example, in some embodiments the citric acid may be reacted with a base prior to incorporation for the bioplastic production. In some embodiments, a base may additionally be included in the bioplastic during production. In such an embodiment, the base may at least partially neutralize the acidity of the citric acid. Further, in some embodiments, the bioplastic may be treated with a base after production (e.g., by soaking, washing, and/or rinsing the bioplastic in a basic solution or liquid. In some such implementations, treating the bioplastic with a base may at least partially neutralize the citric acid. At least partially neutralizing the citric acid may, for example, reduce the magnitude of environmental pH changes exhibited during breakdown of the bioplastic and/or resulting from citric acid leaching from the bioplastic.

Consistent with some embodiments, the bioplastic may include between about 5% to about 40% of the weak acid by weight. Consistent with the foregoing, and as generally discussed with regard to the other components of the bioplastic, the indicated content of citric acid in the bioplastic refers to the content of citric acid, in a substantially dry form (e.g., powdered, granular, etc.) and being 100% citric acid, that is utilized for producing the bioplastics (i.e., the content that is combined with the remaining components of the bioplastic during production). Further, the recited citric acid content is based upon the use of a substantially dry and/or dehydrated Rhodophyta material and a 1:1 agar to water mixture. It will be understood that the citric acid content may vary, e.g., if a non-dry Rhodophyta material is utilized and/or for agar to water mixtures having a ratio other than 1:1. Consistent with some particular illustrative example embodiments, the bioplastic may include between about 5% to about 7% of the weak acid by weight.

As noted above, consistent with some implementations, the bioplastic may include citric acid for the plasticizing properties provided by the citric acid. In some such embodiments, the acidity of the citric acid may not be a significant consideration. Additionally, the content of the citric acid may be based upon, at least in part, the desired end use of the bioplastic. For example, some intended end uses (e.g., a take-out food container) may have relatively low flexibility requirements. As such, relatively less plasticizing may be required and/or desired. According to some such implementations, a relatively lower content of citric acid may be utilized. Correspondingly, some intended end uses (e.g., a plastic bag) may have relatively higher flexibility requirements. As such, relatively more plasticizing may be required and/or desired. According to such some such implementations, a relatively higher content of citric acid may be utilized. Further, in some embodiments, the weak acid may be omitted from the formulation. Consistent with some such implementations, an alternative plasticizer may be utilized. When an alternative plasticizer is utilized, if it is desired to minimize the environmental impact of the bioplastic, it may be desirable to utilize an alternative plasticizer that may be one or more of non-toxic, biodegradable (e.g., may degrade or decompose into relatively environmentally non-damaging components and/or forms), and/or may be of environmentally low-impact.

As discussed above, consistent with the present disclosure, a bioplastic may be generally produced by providing an agar-water mixture, a Rhodophyta material, and a weak acid and/or a plasticizer. The provided components may be combined to form a homogeneous, generally uniform, and/or continuous mixture. Further, consistent with the foregoing, providing the agar-water mixture may include mixing agar (e.g., which may be provided in a substantially dry form, although other configurations may be equally utilized) with water (or other liquid, as generally discussed above) to provide a desired mix ratio. The agar-water mixture may be combined with the Rhodophyta material and weak acid and/or other plasticizer, and the combined components may be mixed using any suitable means and/or apparatus to achieve the generally homogeneous, uniform and/or continuous mixture.

Consistent with some implementations, the combined components may be at least partially dried to achieve a substantially solid configuration. According to some embodiments, of the present disclosure, at least partially drying the mixture may include using any suitable drying and/or dewatering techniques, and/or a combination of different techniques. For example, the mixture may be simply air dried. In some such implementations, the mixture may be cast a film or sheet and allowed to dry at ambient conditions, and/or through the use of elevated temperatures and/or forced convective drying. Further, in some implementations, the mixture may be at least partially dried and/or dewatered via centrifuging, draining using an absorbent substrate and/or a fine mesh substrate (e.g., by which at least a portion of the water may be allowed to separate from the solid components). As noted above, a combination of drying and/or dewatering techniques may be utilized. For example, the mixture may be at least partially dried and/or dewatered via centrifuging and/or draining, and may be subsequently further dried ambiently and/or via elevated temperature and/or forced convention (any of which may occur with the biopolymer in bulk and/or spread into a film or sheet).

Consistent with some implementations, the bioplastic may be shaped into a desired final product as part of the drying process. For example, as noted above, the mixture of components may be cast as a sheet or film. Further, the mixture of components may be cast into other desired shapes. The mixture of components may then be dried in the desired cast shape. Further, in some implementations, the mixture of components may be substantially dried. The resultant bioplastic may then be, e.g., pelletized and/or granulized. From the pellet or granular form, the bioplastic may be subsequently processed and/or shaped using any variety of conventional thermal and/or solvent-based plastic processing techniques, including, but not limited to, vacuum molding, thermoforming, extrusion, injection molding, casting blow-molding, calendaring, etc.

### EXPERIMENTAL EXAMPLES

Various experimental examples were carried out exploring the biodegradability of bioplastics according to some implementations consistent with the present disclosure. The following experimental examples are intended only for illustration and are not intended to be limiting.

During the course of examining possible characteristics of biodegradation of bioplastics consistent with the present disclosure at a range of agar content levels. In particular, experimental samples of bioplastic were prepared including formulations respectively having 25%, 50%, 75%, and 90% agar-water mixture as a percent of the total weight of the initial combination. The test formulations were prepared by completely dissolving agar in water at a 1:1 ratio by weight. The agar-water mixture was then added to weighed portions of algae shavings (i.e., Rhodophyta material) and citric acid. Each test formulation was completely mixed. Once completely mixed, the result of each formulation was spread into a 0.5 cm thick sheet and allowed to completely dry for 24 hours under ambient conditions to provide the test samples for each formulation. The test samples were prepared from formulations as follows:

| | 25% | 50% | 75% | 90% |
|---|---|---|---|---|
| Algae Shavings | 10 g | 10 g | 10 g | 10 g |
| Agar-Water | 6.67 g | 20 g | 60 g | 180 g |
| Citric Acid | 10 g | 10 g | 10 g | 10 g |

Once the samples had completely dried, three 10 cm by 10 cm squares were cut from each of the samples, defining three test specimens for each formulation. A first test specimen for each formulation was submerged in a one-liter freshwater environment. A second test specimen for each formulation was submerged in a one-liter 3.5% saline environment. Prior to submersion the mass of each test specimen was measured and the pH of each test environment was measured.

After 24 hours of submersion in the freshwater environment and in the saline environment, the remains of each test specimen was collected from the respective test tanks and strained through a two-millimeter strainer. The mass of each specimen collected after straining was recorded. After weighing, the remains of each test specimen was re-submerged. Each test specimen was collected and weighed at 24 hour intervals.

A third test specimen for each formulation was inserted into a compost bin. Each test specimen was uncovered weekly and weighted to determine to amount of mass loss due to biodegradation.

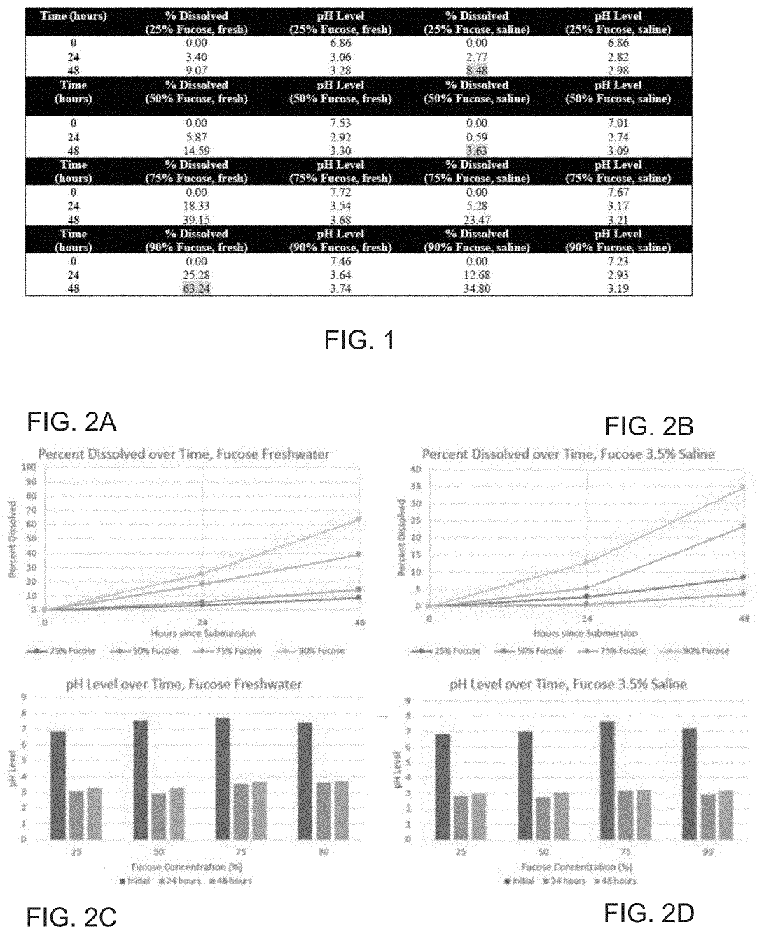

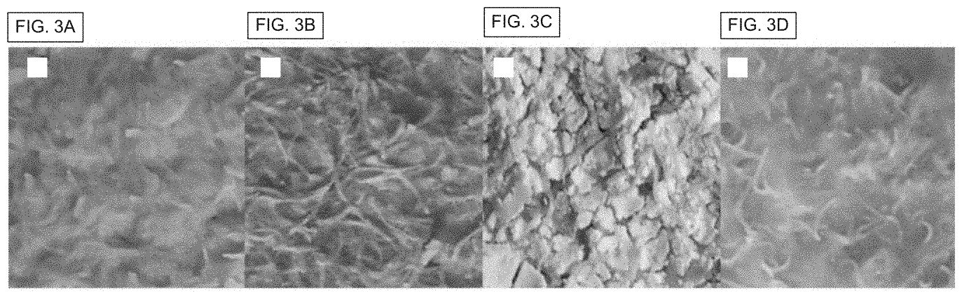

With reference to FIGS. 1 and 2A-2D, it was observed that the 90% fucose (i.e., 90% agar-water mixture) test specimen exhibited the greatest mass loss in the freshwater aqueous environment after 48 hours, with decreasing percent mass loss over 48 hours for decreasing fucose test specimens. Specifically, a 63.24% mass loss was observed for the 90% test specimen after 48 hours. Similarly, the greatest percent mass loss in a saline aqueous environment was also observed in the 90% test specimen, with an observed mass loss of 34.80 percent. For each test specimen a generally similar pH reduction of the aqueous environments was observed. Images of the test specimens are shown in ascending fucose content in FIGS. 3A-3D, respectively. The images shown in FIGS. 3A-3D show the test specimens prior to conducting any testing (e.g., in an as-produced state).

Observations of the composted test specimens demonstrated that all of the test specimens appear to have completely biodegraded after one week exposure to soil environments.

Consistent with observations of the experimental test specimens, it observed that the bioplastic test specimens appear to be significantly water soluble, with up to approximately 63% dissolution achievable after 48 hours in a freshwater environment, and up to approximately 35% dissolution achievable after 48 hours in a saltwater environment. By contrast, a common single use product polymer, polyethylene, exhibits virtually no water solubility, and few existing biodegradable plastics are understood to be tested for water solubility. Similarly, the test specimen exhibited complete biodegradation after one week of exposure to a soil-based environment. By contrast, many known biodegradable plastics may take between six weeks to six months of soil exposure to achieve full degradation, and many common single use plastics may take hundreds of years to degrade.

While various features, embodiments, and implementations have been described, it will be understood that such description is intended for the purpose of illustration and explanation, and should not be construed as limiting on the scope of the present disclosure. Additionally, while several embodiments have been described including various features, it will be understood that the described features are susceptible to combination with features described in connection with out embodiments. As such, the features, advantages, and implementations described across the various embodiments may be combined with one another to provide additional embodiments and implementations. As such, the present disclosure should be understood to encompass any combination of features, advantages, and implementations described herein.

What is claimed is:

1. A bioplastic comprising:
a Rhodophyta material;
agar; and
a weak acid.

2. The bioplastic according to claim 1, the Rhodophyta material is provided in the form of algae shavings.

3. The bioplastic according to claim 1, wherein the Rhodophyta material is provided in a powdered form.

4. The bioplastic according to claim 1, comprising between about 5% to about 40% of the Rhodophyta material by weight.

5. The bioplastic according to claim 1, comprising between about 10% to about 15% of the Rhodophyta material by weight.

6. The bioplastic according to claim 1, wherein the agar is provided as a 1:1 agar: water mixture by weight.

7. The bioplastic according to claim 6, comprising between about 25% to about 90% of the agar: water mixture by weight.

8. The bioplastic according to claim 6, comprising between about 75% to about 85% of the agar: water mixture by weight.

9. The bioplastic according to claim 1, wherein the weak acid has a pH of between about 3 to about 6.

10. The bioplastic according to claim 1, wherein the weak acid includes citric acid.

11. The bioplastic according to claim 1, comprising between about 5% to about 40% of the weak acid by weight.

12. The bioplastic according to claim 1, comprising between about 5% to about 7% of the weak acid by weight.

13. A method of making a bioplastic comprising:
providing a 1:1 by weight agar: water mixture;
providing a Rhodophyta material;
providing a weak acid; and
combining the agar: water mixture, the Rhodophyta material, and the weak acid.

14. The method according to claim 13, further comprising drying the combined agar: water mixture, Rhodophyta material, and weak acid.

15. The method according to claim 13, wherein the Rhodophyta material includes one or more of algae shavings and algae power.

16. The method according to claim 13, wherein providing the Rhodophyta material includes providing between about 5% to about 40% of the Rhodophyta material by weight.

17. The method according to claim 13, wherein providing the agar: water mixture includes providing between about 25% to about 90% of the agar: water mixture by weight.

18. The method according to claim 13, wherein the weak acid has a pH of between about 3 to about 6.

19. The method according to claim 13, wherein the weak acid includes citric acid.

20. The method according to claim 13, wherein providing the weak acid includes providing between about 5% to about 40% of the weak acid by weight.
